(19) United States
(12) Patent Application Publication
(10) Pub. No.: US 2026/0205042 A1
(43) Pub. Date: Jul. 16, 2026

(54) METHOD FOR RECORDING AN INITIAL ROTATIONAL POSITION OF A ROTOR

(71) Applicant: Schaeffler Technologies AG & Co. KG, Herzogenaurach (DE)

(72) Inventors: Erhard Hodrus, Achern (DE); Christian Eberle, Bühl (DE); Alexander Rösch, Achern (DE)

(73) Assignee: Schaeffler Technologies AG & Co. KG, Herzogenaurach (DE)

(21) Appl. No.: 19/137,931

(22) PCT Filed: Nov. 28, 2023
(86) PCT No.: PCT/DE2023/100926

§ 371 Date: Jun. 11, 2025

(30) Foreign Application Priority Data
Dec. 19, 2022 (DE) 10 2022 133 896.7

(51) Int. Cl. H02P 23/14

(52) U.S. Cl. CPC H02P 23/14

(57) ABSTRACT

A method for recording an initial rotational position of an at-rest rotor of an electric motor with respect to a stator by carrying out a current response recording in which a high-frequency injection signal is introduced along a recording direction in a dq coordinate system of the electric motor.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100926, filed on Nov. 28, 2023, designating the United States of America, which in turn claims the benefit of priority under 35 U.S.C. § § 119, 365 of German Patent Application No. 10 2022 133 896.7 filed on Dec. 19, 2022, the contents of which are relied upon and incorporated herein by reference in their entirety.

### FIELD OF THE DISCLOSURE

The disclosure relates to a method for recording an initial rotational position of a rotor of an electric motor

### BACKGROUND OF THE DISCLOSURE

EP 2 194 641 A1 describes a method for determining an initial rotational position of a permanent magnet rotor of an electric motor, in which the saturation behavior of ferromagnetic motor windings is used to detect and correct a 180° error when the initial rotational position is established. A specified degree of saturation of the ferromagnetic material is tested before the test is carried out for a 180° rotation.

From KITAMURA, Kentaro; TAKUMI, Nimura; DOKI, Shinji: Position sensorless control method by using redefined extended electromotive force for all-speed-range drive of IPMSM and its evaluation on electric vehicle. In: 2020 IEEE 29th International Symposium on Industrial Electronics (ISIE), Jun. 17-19, 2020, Delft, Netherlands. 2020, P.351-356. ISBN 978-1-7281-5636-1. DOI: 10.1109/ISIE45063.2020.9152459, a method is known for recording an initial rotational position of an electric motor rotor by performing a current response recording. A high-frequency injection signal is introduced along a recording direction and a current variable is recorded as a current response to the injection signal.

### SUMMARY OF THE DISCLOSURE

The object of the present disclosure is to detect a 180° offset between the presumed and the actual initial rotational position of the rotor more quickly and reliably.

At least one of these objects is achieved by a method for recording an initial rotational position with the features according to claim 1. This allows a 180° offset in the presumed d-direction to be detected more quickly and accurately. This can prevent faulty operation of the electric motor.

The electric motor can be arranged in a vehicle, such as in a drive train of the vehicle. The electric motor can have a number of circumferentially distributed ring windings. The ring windings can have at least one ferromagnetic iron core.

The recording of the initial rotational position can be sensorless, i.e., without using a sensor that measures the rotational position of the rotor in relation to the stator. This allows the electric motor to be constructed more cost-effectively. The wiring otherwise required for the sensor can be omitted.

The initial rotational position is defined as the angular position of the rotor relative to the stator when the rotor is at-rest, i.e., initially not rotating. The initial rotational position may be the angular position of the rotor before drive power of the electric motor is built up.

The electric motor can be arranged to operate at least one pump of the vehicle. The pump can provide a fluid pressure for actuating at least one vehicle component of the vehicle and/or a fluid volume flow for cooling at least one vehicle component of the vehicle.

In the first and second current response recording, particular use is made of the fact that the current response changes as a function of the direction of the constant current value due to a direction-dependent saturation of the ferromagnetic material in the ring windings of the stator.

The first current response recording can be carried out before or after the second current response recording.

In some embodiments of the disclosure, it is advantageous if a multi-angle current variable recording is carried out during the current response recording, in which, on the one hand, a current variable along a first direction offset by a first angle relative to the recording direction is detected as the first recorded current variable and, on the other hand, a current variable along a second direction offset by a second angle relative to the recording direction is detected as the second recorded current variable and the recording current variable is calculated as a function of the first and second recorded current variables. The first angle is preferably +45° and the second angle is preferably −45° with respect to the recording direction or vice versa. The recording current variable can be a sum of the squares of the first and second recorded current variables.

In some embodiments of the disclosure, it is advantageous if the multi-angle current variable recording is performed in the first current response recording, in which the first and second angles are related to the first recording direction and the recording current variable forms the first current recording value. This allows the first current recording value to be determined more accurately. The first current recording value can be a sum of the squares of the first and second recorded current variables.

Embodiments of the disclosure can be advantageous if the multi-angle current variable recording is performed in the second current response recording, in which the first and second angles are related to the second recording direction and the recording current variable forms the second current recording value. This allows the second current recording value to be determined more accurately. The second current recording value can be a sum of the squares of the first and second recorded current variables.

In some embodiments of the disclosure, it is provided that a possible 180° offset between the first recording direction and the actual d-direction is established as a function of an amplitude ratio of the first and second current recording values. The first and/or second current recording value can be pre-processed (e.g., filtered) to calculate the amplitude ratio.

In some embodiments of the disclosure, it is advantageous if the amplitude ratio is an amplitude difference of an amount of the first current recording value and an amount of the second current recording value. The amplitude difference can be a difference between an amplitude of the first current recording value and an amplitude of the second current recording value. The amplitude difference can also be a difference between a square of the amplitude of the first current recording value and a square of the amplitude of the second current recording value.

In some embodiments of the disclosure, it is provided that if the amplitude difference is negative, a 180° offset is established. The presumed d-direction can then be corrected by 180°.

In some embodiments of the disclosure, if the amplitude difference is positive, a 180° offset is excluded. A correction of the presumed d-direction may not occur.

In some embodiments of the disclosure, it is advantageous if the first and second constant current values are equal in amount. The first constant current value can be positive and the second constant current value can be negative due to the second recording direction being offset by 180° from the first recording direction.

In some embodiments of the disclosure, it is advantageous if the rotor is a permanent magnet rotor and/or the electric motor is a brushless DC motor. If the magnetic flux of the permanent magnet of the permanent magnet rotor saturates the iron core of the ring winding of the stator, a change in the alignment of the magnetic axes of the rotor in relation to the ring winding leads to a change in the inductive properties of the ring winding. If the magnetic flux of the permanent magnet rotor is aligned with the ring winding, then the iron core is saturated to the maximum and the coil inductance in the ring winding is reduced. As a result, the current response changes as a function of the rotational position of the rotor in relation to the ring winding.

Furthermore, the disclosure relates to an electric motor which is configured to carry out the method with at least one of the features described above.

Further advantages and advantageous embodiments of the disclosure arise from the description of the figures and the drawings.

### BRIEF DESCRIPTION OF THE DRAWINGS

The disclosure is described in detail below with reference to the drawings. In the drawings, in particular:

FIG. 1 shows an electric motor for carrying out a method for recording an initial rotational position in a particular embodiment of the disclosure.

FIG. 2 shows a curve diagram showing the execution of a method in a particular embodiment of the disclosure.

### DETAILED DESCRIPTION

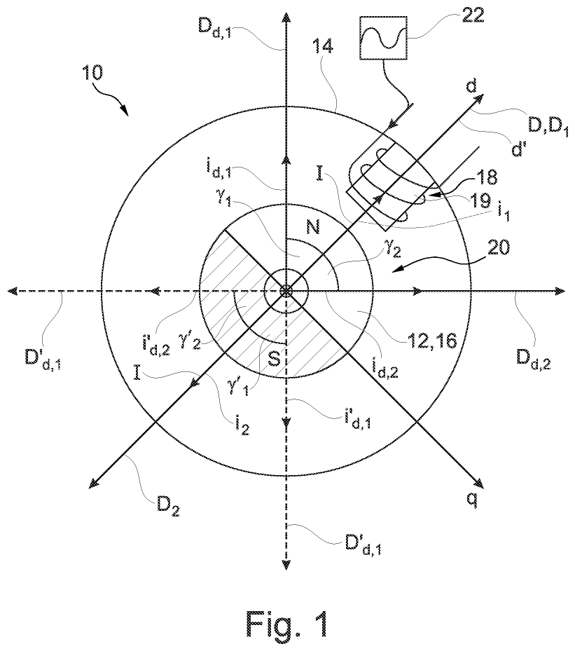

FIG. 1 shows an electric motor for carrying out a method in some embodiments of the disclosure. The electric motor 10 comprises a rotor 12, which is rotatable relative to a stator 14. The rotor 12 can be a permanent magnet rotor 16, which is driven by ring windings 18 of the stator 14 as a function of an electrical control. The ring windings 18 are reduced to a single ring winding 18 in the drawing, but it is to be understood that ring windings 18 may be distributed evenly around the circumference of the stator 14.

The ring winding 18 comprises at least one ferromagnetic iron core 19 and is electrically connected to a control unit (e.g., inverter) which sets electrical operating variables, such as a voltage and/or a current on the ring winding 18. The electrical operating variables can be related to the dq coordinate system of the rotor 12. The dq coordinate system is the reference system of the electrical operating variables that rotates with the rotor 12 and is obtained by the Park transformation.

When the rotor 12 is initially at rest relative to the stator 14, the initial rotational position 20, i.e., the rotational position of the rotor 12 relative to the stator 14, is decisive for starting operation of the electric motor 10. In the present case, the initial rotational position 20 is recorded without sensors, i.e., without additional sensors, by recording electrical parameters of the electric motor 10, by, for example, means of current response recording, in which a high-frequency injection signal 22 is introduced along a recording direction D in the dq coordinate system of the electric motor 10 and at least one current variable is recorded as the recording current variable I as a current response to the injection signal 22.

If a presumed d-direction d′ is determined by using the current response recording, there may still be a 180° offset between the presumed d-direction d′ and the actual d-direction. This 180° offset can be recorded using the method described in more detail below.

Firstly, a first current response recording is carried out along the first recording direction D₁ assumed to be the presumed d-direction d′, in which the injection signal 22 is overlaid with a first constant current value in the first recording direction v and the recording current variable I is recorded as the first current recording value i₁. Then, a second current response recording is carried out along a second recording direction D₁ opposite to the first recording direction D₂ in which the injection signal 22 is overlaid with a second constant current value in the second recording direction D₂ and the recording current variable I is recorded as a second current recording value i₂.

In the first current response recording, a multi-angle current variable recording is carried out, in which, on the one hand, a current magnitude is detected along a first direction D_{d,1} offset by a first angle γ₁, such as −45° relative to the first recording direction D₁, as the first recorded current variable i_{d,1} and, on the other hand, a current variable is recorded along a second direction D_{d,2} offset by a second angle 12, such as ±45° relative to the first recording direction D₁, as the second recorded current variable i_{d,2}, and the first current recording value in is calculated as the recording current variable I as a function of the first and second recorded current variable I_{d,1}, I_{d,2}.

In the second current response recording, a multi-angle current variable recording is also carried out, in which, on the one hand, a current magnitude is detected along a first direction

$${D}_{d , 1}^{′}$$

offset by the first angle

$${γ}_{1}^{′}$$

relative to the second recording direction D₂, as the first recorded current variable

$${i}_{d , 1}^{′}$$

and, on the other hand, a current variable is recorded along a second direction

$${D}_{d , 2}^{′}$$

offset by the second angle

$${γ}_{2}^{′}$$

relative to the first recording direction D₁, as the second recorded current variable

$${i}_{d , 2}^{′} ,$$

and the second current recording value i₂ is calculated as the recording current variable I as a function of the first and second recorded current variable

$${i}_{d , 1}^{′} , {i}_{d , 2}^{′} .$$

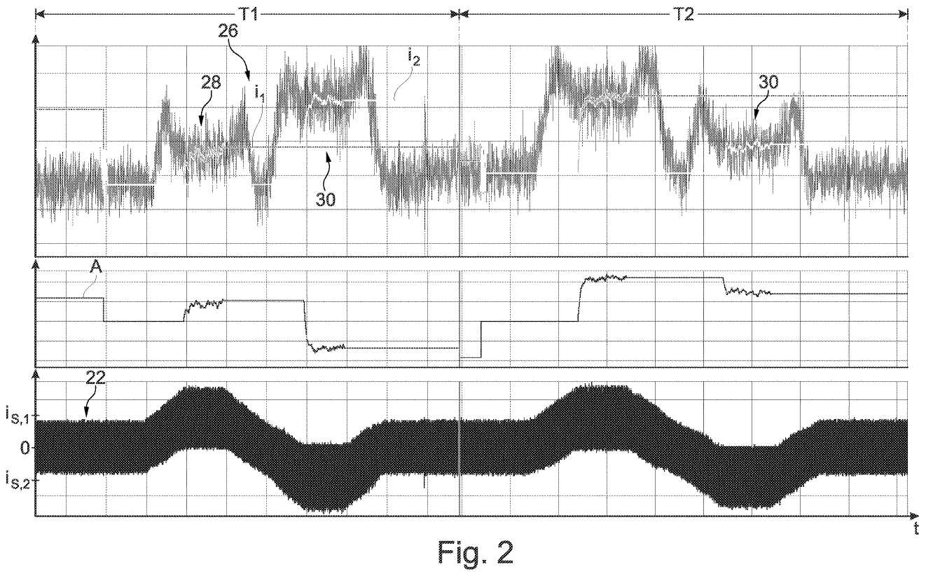

FIG. 2 shows a curve diagram showing the execution of a method in an embodiment of the disclosure. The method 26 for recording the initial rotational position of the rotor may be carried out with an at-rest rotor and is explained below using a time curve diagram of various parameters of the electric motor, initially with respect to a first time interval T1.

Initially, with an at-rest rotor, the injection signal 22 is overlaid with a first constant current value i_{s,1}. The injection signal 22 resembles a band due to the high-frequency component. Then, the injection signal 22 is overlaid with a second constant current value i_{s,2}. The first and second constant current values i_{s,1}, i_{s,2} are equal in amount. The first constant current value i_{s,1} as an impressed constant current in the first recording direction is positive and the second constant current value i_{s,2} is negative due to the second recording direction D₂ being opposite to the first recording direction D₁.

The first current response recording 28 is carried out with the set first constant current value i_{s,1}, with which the first current recording value in is calculated as the sum of the squares of the first and second detected current variable as a multi-angle current variable recording. The first current recording value i₁ increases when overlaid with the first constant current value i_{s,1}.

A second current response recording 30 is carried out with the set second constant current value i_{s,2}, with which the second current recording value i₂ is calculated as the sum of the squares of the first and second detected current variable as a multi-angle current variable recording. The second current recording value increases when overlaid with the second constant current value i_{s,2}.

The possible 180° offset between the first recording direction and the actual d-direction is established as a function of an amplitude ratio A of the first and second current recording values i₁, i₂. This amplitude ratio A is a filtered signal of the amplitude difference, which in turn is calculated from an amount of the first current recording value i₁ and an amount of the second current recording value i₂.

The amplitude ratio A is evaluated after completion of the second current response recording 30 and if this is negative, then a 180° offset is concluded, since the permanent magnet of the rotor is aligned in the second recording direction and thus the actual d-direction is aligned in the second recording direction. This means that the d-direction presumed to run along the first recording direction can then be corrected by 180°.

In the second time interval T2, the amplitude ratio A is positive after carrying out the second current response recording 30 and a 180° offset is excluded. The presumed d-direction is not corrected by 180°.

### LIST OF REFERENCE SYMBOLS

A Amplitude ratio
D Recording direction
D′_{d,1} First direction
D′_{d,2} Second direction
D₁ First recording direction
D₂ Second recording direction
D_{d,1} First direction
D_{d,2} Second direction
I Recording current variable
γ₁^{′}First angle
γ₂^{′}Second angle
γ₁ First angle
γ₂ Second angle
d′ Presumed d-direction
i′_{d,1} First recorded current variable
i′_{d,2} Second recorded current variable
i₁ First current recording value
i₂ Second current recording value
i_{d,1} First recorded current variable
i_{d,2} Second recorded current variable
i_{s,1} First constant current value
i_{s,2} Second constant current value
10 Electric motor
12 Rotor
14 Stator
16 Permanent magnet rotor
18 Ring winding
19 Iron core
20 Initial rotational position
22 Injection signal
26 Method
28 First current response recording
30 Second current response recording

1. A method for recording an initial rotational position of an at-rest rotor of an electric motor with respect to a stator, in that a current response recording is carried out, in which a high-frequency injection signal is introduced along a recording direction in a dq coordinate system of the electric motor and at least one current variable is recorded as a recording current variable as a current response to the injection signal, wherein;
a first current response recording along a first recording direction as a presumed d-direction is carried out in which the injection signal is overlaid with a first constant current value in the first recording direction and the recording current variable is recorded as a first current recording value;
a second current response recording is carried out along a second recording direction opposite to the first recording direction in which the injection signal is overlaid with a second constant current value in the second recording direction and the recording current variable is recorded as a second current recording value; and
after the first and second current response recordings, a possible 180° offset between the first recording direction and the actual d-direction is established as a function of a ratio of the first and second current recording values, wherein a multi-angle current variable recording is carried out during the current response recording, in which, on the one hand, a current variable along a first direction offset by a first angle relative to the recording direction is detected as a first recorded current variable and, on the other hand, a current variable along a second direction offset by a second angle relative to the recording direction is detected as a second recorded current variable and the recording current variable is calculated as a function of first and second detected current magnitudes.

2. The method for recording an initial rotational position of claim 1, wherein the multi-angle current variable recording is performed in the first current response recording, in which the first and second angles are related to the first recording direction and the recording current variable forms the first current recording value.

3. The method for recording an initial rotational position of claim 1, wherein the multi-angle current variable recording is performed in the second current response recording, in which the first and second angles are related to the second recording direction and the recording current variable forms the second current recording value.

4. The method for recording an initial rotational position of claim 1, wherein a possible 180° offset between the first recording direction and the actual d-direction is established as a function of an amplitude ratio of the first and second current recording values.

5. The method for recording an initial rotational position of claim 4, wherein the amplitude ratio is an amplitude difference of an amount of the first current recording value and an amount of the second current recording value.

6. The method for recording an initial rotational position of claim 5, wherein, if the amplitude difference is negative, a 180° offset is established.

7. The method for recording an initial rotational position of claim 6, wherein, if the amplitude difference is positive, a 180° offset is excluded.

8. The method for recording an initial rotational position of claim 1, wherein the first and second constant current values are equal in amount.

9. The method for recording an initial rotational position of claim 1, wherein at least one of the rotor is a permanent magnet rotor and the electric motor is a brushless DC motor.

10. An electric motor system, comprising:
a stator including at least one winding;
a rotor mounted for rotation with respect to the stator; and
a control unit operatively coupled to the at least one winding and configured to:
while the rotor is at rest, inject a high-frequency signal along a first recording direction that follows a presumed d-axis that is presumed to coincide with an actual d-axis of a dq reference frame that has a fixed orientation relative to the rotor;
superimpose a first constant current value on the high-frequency signal in the first recording direction and acquire, as a first recording value, a current response produced by the at least one winding;
inject a high-frequency signal along a second recording direction that is 180 degrees offset from the first recording direction;
superimpose a second constant current value in the second recording direction and acquire, as a second recording value, a current response produced by the at least one winding;
compare an amplitude of the first current recording value with an amplitude of the second current recording value; and
determine whether there is a possible 180 degree offset between the presumed d-axis and the actual d-axis of the rotor based on the comparison of the amplitudes.

11. The electric motor system of claim 10, wherein the control unit determines there is a possible 180 degree offset between the presumed d-axis and the actual d-axis based on a difference between the amplitude of the first current recording value and the amplitude of the second current recording value being negative.

12. The electric motor system of claim 10, wherein the control unit determines there is not a possible 180 degree offset between the presumed d-axis and the actual d-axis based on a difference between the amplitude of the first current recording value and the amplitude of the second current recording value being positive.

13. The electric motor system of claim 10, wherein the rotor is a permanent magnet rotor.

14. The electric motor system of claim 10, wherein the at least one winding includes a plurality of ring windings.
